(19) United States
(12) Patent Application Publication
(10) Pub. No.: US 2008/0062311 A1
(43) Pub. Date: Mar. 13, 2008

(54) Methods and Devices to Use Two Different Clocks in a Television Digital Encoder

(76) Inventors: Jiliang Song, Surrey (CA); Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/531,661

(22) Filed: Sep. 13, 2006

(51) Int. Cl. H04N 11/20

(52) U.S. Cl. 348/457

(57) ABSTRACT

The present invention provides a method and a device that use two different clock frequencies to encode video. The method and device would allow videos taken by an electronic device with input clock frequency other than 27 MHz, to be encoded by using two clock frequencies for playing back on TV. An exemplary method capable of using two clock frequencies to encode digital video data captured by a video-capturing device is provided. The method includes re-sampling luminance and chrominance data in a re-sampling module to convert the luminance and the chrominance data in a 27 MHz clock domain to be in an input clock domain other than 27 MHz of an input clock of the video-capturing device. The method also includes modulating re-sampled chrominance data in the input clock domain by color subcarrier signals driven by the input clock. The method further includes combining the modulated re-sampled chrominance data and the re-sampled luminance data, and converting the combined modulated re-sampled chrominance data and re-sampled luminance data into analog signals.

### CROSS REFERENCE TO RELATED APPLICATION

This application is related to U.S. patent application Ser. No. _______ (Attorney Docket No. VP226) filed on the same day as the instant application and entitled “Methods And Devices To Use A 26 MHz Clock To Encode Videos.” The disclosure of this related application is incorporated herein by reference in its entirety for all purposes.

### BACKGROUND

Television (TV) is a widely used household electronic device. The TV broadcasting process is accomplished when changes in differing light values in a “scene” are converted by a camera to correspond to the changes in light values. These changes in voltage and current make up video signals. The “scene”, in the form of video signals, is transmitted to a receiver. At the receiver, the video signals become a reassembled image on the screen of the television.

Television signals are transmitted in standard analog format. TV encoders convert digital video data into standard analog baseband television signals. TV encoders follow three standards. One is National TV standards committee (NTSC) standard, used in countries such as United States and Japan. The second one is the Phase Alternating Line (PAL) standard, used in most of the European countries. The third one is Sequential Color with Memory (SECAM) standard, used in some countries in Europe and Asia. Most of TV and video recorders use 27 MHz clocks, because 27 MHz clocks give integer number (or full) cycles per line on TV screens for both PAL and NTSC systems. 27 MHz clocks meet the requirements for Discrete Time Oscillator (DTO) and TV bandwidth.

As described above, the input clock (or CLKI) for TV encoder typically run at 27 MHz, since this frequency gives integer number (or full) cycles per line for both PAL and NTSC systems, and meet the requirements for DTO and TV bandwidth. The integer number cycles per line simplify circuit logic implementation. The logic circuit can easily generate accurate TV timing. However, newly developed video capturing devices, such as cell phones are becoming more popular. These video capturing devices do not have an input clock at 27 MHz clock. For example, cell phones have input clock running at 26 MHz, instead of 27 MHz. It may be desirable for videos captured with these new devices would sometimes to be played back on the TV.

To play back these videos on the TV, the videos first need to be encoded. Therefore, there is a need for a TV encoder in the new device that allows videos taken by the new device with input clock frequency other than 27 MHz to be encoded and to be played back on TV.

### SUMMARY

Broadly speaking, the present invention fills these needs by providing a method and a device that use two different clock frequencies to encode video. The method and device would allow videos taken by an electronic device with input clock frequency other than 27 MHz, to be encoded for playing back on TV. It should be appreciated that the present invention can be implemented in numerous ways, including as a process, an apparatus, a system, a device, or a method. Several inventive embodiments of the present invention are described below.

In one embodiment, an encoding device capable of using two clock frequencies to encode digital video data is provided. The device includes an input clock operating at a clock frequency other than 27 MHz, and a phase-locked loop (PLL) configured to generate a 27 MHz clock from the input clock. The device also includes a re-sampling module to convert luminance and chrominance data representing the digital video data from a 27 MHz clock domain to a clock domain of the input clock. The device further includes a color subcarrier generator driven by the input clock to generate color subcarrier signals, the chrominance data from the re-sampling module are modulated by the color subcarrier signals, wherein modulated chrominance data are eventually combined with the luminance data from the re-sampling module. In addition, the device includes a digital to analog converter (DAC) to convert the modulated chrominance data which are eventually combined with the luminance data from the re-sampling module into analog signals.

In another embodiment, a method capable of using two clock frequencies to encode digital video data captured by a video-capturing device is provided. The method includes re-sampling luminance and chrominance data in a re-sampling module to convert the luminance and the chrominance data in a 27 MHz clock domain to be in an input clock domain other than 27 MHz of an input clock of the video-capturing device. The method also includes modulating re-sampled chrominance data in the input clock domain by color subcarrier signals driven by the input clock. The method further includes combining the modulated re-sampled chrominance data and the re-sampled luminance data, and converting the combined modulated re-sampled chrominance data and re-sampled luminance data into analog signals.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a schematic diagram of a TV digital encoder.

FIG. 2 is a schematic diagram of an exemplary embodiment of a TV encoder that encodes video with multiple clock frequencies.

FIG. 3 shows a schematic diagram of an exemplary embodiment of a method of video re-sampling for a TV encoder of FIG. 2.

FIG. 4 is a schematic diagram of an exemplary embodiment of a TV encoder that encodes video with a 26 MHz clock frequency.

FIG. 5 shows a schematic diagram of an exemplary embodiment of a method of video re-sampling for a TV encoder of FIG. 4.

### DETAILED DESCRIPTION

In the following description, numerous specific details are set forth in order to provide a thorough understanding of the present invention. However, it will be apparent to those skilled in the art that the present invention may be practiced without some of these specific details. In other instances, well known process operations and implementation details have not been described in detail in order to avoid unnecessarily obscuring the invention.

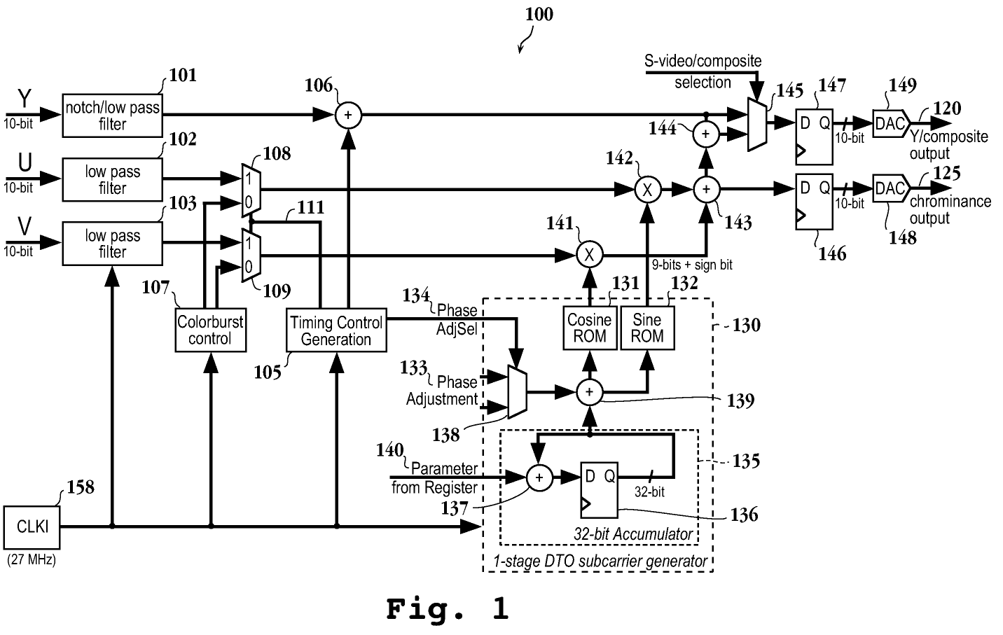

FIG. 1 shows an exemplary diagram 100 of a typical television (TV) digital encoder that encodes incoming luminance and chrominance (YUV) data as required for the NTSC and PAL TV standards. The output data of the encoder are either a 10-bit S-video (Separate video) or a composite video that drives 10-bit Digital-to-Analog Converters (DACs) to produce analog video signals.

The incoming Y (luminance) component first goes through either a notch filter (for composite video) or a low-pass filter (for S-video) 101. A notch filter blocks a narrow band of frequencies and passes frequencies above and below the band. It can be used to remove signals in the color subcarrier frequency ranging from the luminance data and eventually improves decoded video quality for composite video. A low-pass filter can be used to block out high-frequency components (above 6 MHz) generated as a result of 2× over-sampling, which is used for NTSC and PAL systems. The UV (chrominance or color) components first go through low-pass filters 102, 103, which minimize ringing and overshoot, and avoid the generation of visual artifacts on sharp edges. The UV components are filtered to about 1.3 MHz. Low-pass filters, 102 and 103, for chrominance components typically are Gaussian filters. The low-pass filters, 102 and 103, can also be combined into one filter.

The timing information from a timing/control generator 105 is then inserted in the filtered Y data through an adder 106. The inserted timing information allows the encoder video data to be reassembled accurately on the TV screen. Color burst information from controller 107 is added in the filtered UV data through multiplexers (MUXs) 108, 109 to provide color reference. Color burst for the chrominance data are synchronized with luminance data through connection 111. By synchronizing the color burst at the beginning of each scan line with an input clock (CLKI) 158, a television receiver is able to restore the suppressed carrier of the chrominance signals, and in turn decide the color information. In NTSC, the color burst frequency is 3.579545 MHz with a phase of 180°, whereas PAL uses a frequency of 4.43361875 MHz, with its phase alternating between 135° and 225° from line to line.

After the timing control and color burst control data are added to the YUV data, the UV data are modulated by the color subcarrier by multiplying the U components with “sine” values (U×sine) and multiplying the V components with “cosine” values (V×cosine) and added together through adder 141. The sine and cosine values of the color subcarrier are generated by an 1-stage (32-bit) Discrete Time Oscillator (DTO) 130. The DTO includes a 32-bit accumulator (ACC) 135 and sine and cosine ROMs 131, 132. The 32-bit ACC is reset every 2 frames for NTSC systems or every 4 frames for PAL systems to avoid accumulative errors. The “sine” and “cosine” values are generated by sine ROM (read only memory) 132 and cosine ROM 131, which contain sine and cosine tables. ROMs 131, 132 receive 11-bit input values for sine and cosine ROMS from a 32-bit accumulator 135 to generate accurate sine and cosine values.

The accumulator 135 receives a parameter from register 140, which can be initialized by the host at any time or can be set to default values according to TV standards during power-up. The parameter equals (f_{sc}/f_{clkDto})*2³², where f_{sc} is the frequency of the color subcarrier and f_{clkDto} is the frequency of the clock used in the DTO. f_{sc} is 3.579545 MHz for NTSC, and 4.43361875 MHz for PAL. The accumulator 135 generates 11-bit input values with a data buffer 136, which can utilize a flip-flop or other memory cells, and an adder 137. A data buffer takes an input and conveys to the output when the clock is strobed. “Phase AdjSel” 134 comes from the “timing control generation” and is used to select certain phase shift for the subcarrier phase adjustment. The adjustment depends on TV standard and the timing. Table 1 shows the adjustment for NTSC and PAL.

TABLE 1
Phase adjustment for NTSC and PAL.

PAL

| | NTSC | switch = 0 | switch = 1 |
|---|---|---|---|
| Active video | 180° | 225° | 135° |
| Non-active video | 0° | 0° | 90° |

### With the phase adjustment, the color burst in NTSC has a phase shift of 180° relative to U, whereas, the color bust in PAL has a phase shift alternating between 135° and 225° from line to line relative to U.

The phase adjustment(s) 133 for NTSC or PAL is entered to MUX 138 along with phase AdjSel 134 to generate overall phase adjustment for the sine and cosine ROMS. MUX 138 produces the overall phase adjustment and provides it to adder 139, which also takes inputs of the 11-bit interval values, generated by accumulator 135. 11 bits of the 32-bit accumulator are used to generate accurate input values for the sine and cosine ROMs 132, 131.

Adder 139 produces overall input values for the sine and cosine ROMs 132, 131 to generate accurate sine and cosine values to modulate UV data by using multipliers 141, 142. The sine and cosine values can be represented by 9-bit values for quarters (π/2) of the sine and cosine waves and accompanying sign bits. The 9-bits values and accompanying sign bits can be used to represent the whole sine and cosine waves (2π). The modulated UV data are then added together through adder 143 to produce overall modulated chrominance data, which are provided to a data buffer 146 and to adder 144 to produce composite data with the luminance data. The data buffer 146, which can implement a flip-flop or other memory cells, allows DAC 148 one whole clock to convert the digital data to analog signal. Luminance data, composite data and a S-video or composite video selection are fed together into MUX 145 and then to data buffer 147. Similarly, the data buffer 147 allows DAC 149 one whole clock to convert the digital data to analog signal. The chrominance data and luminance data with composite data are converted into analog signals 120, 125 by DACs 148, 149 for transmission to TV decoder.

The color subcarrier is derived directly from the input clock (CLKI) 150, which is generated by a clock module, such as an oscillator, and is typically at 27 MHz for TV encoder. Any clock jitter or frequency deviation of an input clock 150 (or CLKI) will be transferred directly to the color subcarrier, which will result in hue noise on the color subcarrier. Periodic or coherent hue noise can result in differential phase error that causes noise in the decoded image. Inside a TV, typically there is a PLL module to “lock” the incoming subcarrier signal. The PLL has limited “lock” range. If the input signal is out of the range, the PLL cannot lock to the input signal. Bigger frequency deviation of CLKI can cause the TV receiver to lose the lock to the subcarrier signal and the color in the decoded image. Therefore CLKI should be very accurate and with almost no jitter.

As described above, input clock (or CLKI) for TV encoder typically run at 27 MHz. This frequency gives integer number (or full) cycles per line for both PAL and NTSC systems, and meet the requirements for DTO and TV bandwidth. The integer number cycles per line simplify circuit logic implementation. The logic circuit can easily generate accurate TV timing. However, newly developed video capturing devices, such as cell phones, do not have an input clock at 27 MHz clock. For example, cell phones have input clocks running at 26 MHz, instead of 27 MHz.

To convert digital video data, captured by a device with input clock other than 27 MHz, into standard analog baseband (NTSC/PAL) television signals, one possible solution is to add a new crystal-based 27 MHz clock on the printed circuit board (PCB) of the device. However, adding a new crystal-based 27 MHz clock increases production cost and consumes valuable space on the video-capturing device, such as a cell phone, that has limited space. Another solution is to use an on-chip phase-locked loop (PLL) to generate a 27 MHz clock from the non-27 MHz clock to encode the video. A PLL is a closed-loop feedback control system that maintains a generated signal in a fixed phase relationship to a reference signal. The PLL can convert a clock with a frequency, such as 26 MHz, into a 27 MHz clock and functions as a clock generator. However, the PLL would amplify clock jitter, which can cause severe hue noise on the decoded image.

As described above, any jitter or frequency deviation of clock will be transferred directly to the color subcarrier. Large jitter within a clock cycle interval will result in hue noise on the color subcarrier. Therefore, the clock used for the color subcarrier needs to be very accurate and with very small jitter. For consumer and industrial applications, the maximum total deviation of the clock for the color subcarrier should be limited to 50 ppm for NTSC systems or 25 ppm for PAL systems. Therefore, the clock used for the color subcarrier should not be a clock generated by a PLL, which amplifies clock jitter. The clock used for the color subcarrier should be a clock with low jitter, such as an input clock generated by a clock module (e.g. a crystal). In contrast, the clock used for the timing control and color burst control can tolerate some degree of clock jitter.

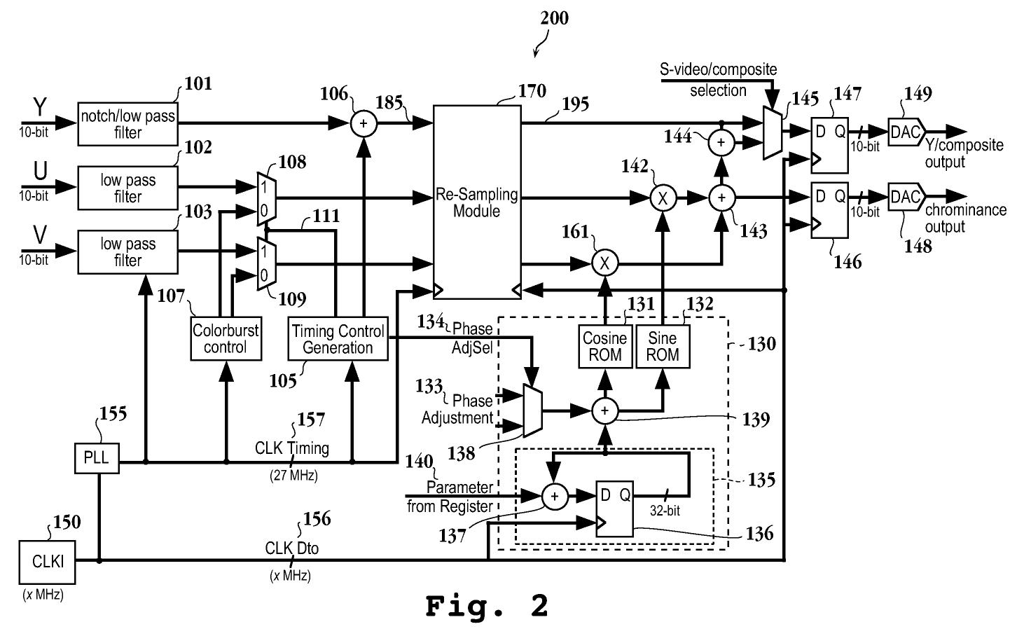

FIG. 2 shows a diagram of an exemplary embodiment of a TV encoder that encodes digital video taken with a device with an input clock frequency other than 27 MHz. The TV encoder can be on a graphic engine chip (or processing unit) on the cell phone or a separate chip. This embodiment is providing a simple way to use clocks with two different frequencies in a TV encoder. One clock is used for the Discrete Time Oscillator (DTO) 130, which is a color subcarrier generator. The other is used for timing generation and color burst control. The clock used for DTO, referred to as ClkDto 156, comes from an input clock (CLKI) 150, which has high accuracy and very small jitter. Therefore, ClkDto 156 can generate a very accurate color subcarrier. The clock used for timing generation and color burst control, referred to as ClkTiming 157, comes from a PLL 155 driven by the input clock (CLKI) 150. The PLL 155 generates a 27 MHz clock. The 27 MHz clock generated by the PLL 155 is not as accurate as the ClkDto 156, and has larger jitter than ClkDto 156, which comes directly from the input clock CLKI 150. As described above, the timing for horizontal synchronization can tolerate a larger clock jitter without sacrificing image quality. Using a PLL to generate 27 MHz frequency simplifies the timing design, since the existing timing design logic can be used. The embodiments described herein can support CLKI 150 frequency ranging from about 18 MHz to less than 27 MHz, or higher than 27 MHz. The minimal clock frequency has to be greater than or equal to 4 times the subcarrier frequency. For NTSC, the minimal clock frequency is 3.579545×4 (or 14.31818) MHz, while for PAL, the minimal clock frequency is 4.43361875×4 (or 17.734475) MHz. In the case of a cell phone, the input clock (CLKI) that is used for ClkDto has a 26 MHz frequency.

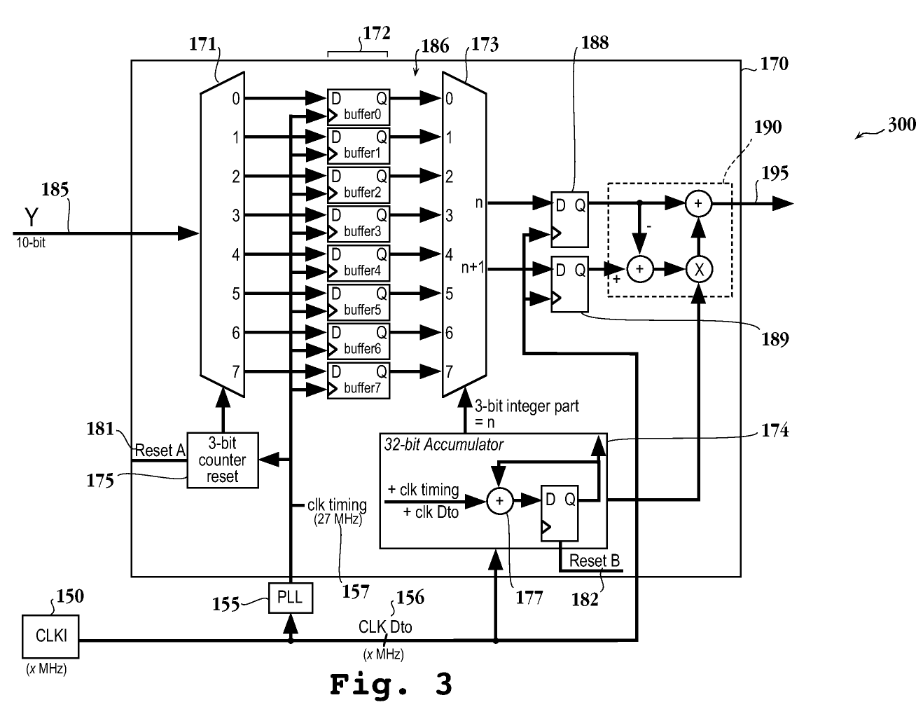

The filtered YUV data are added with timing control and color burst control generated at a clock (ClkTiming 157) different from the clock (ClkDto 156) of sine/cosine modulated color subcarrier data. The ClkTiming is at 27 MHz and is generated by a PLL 155. The 1-stage DTO 130 is driven by a ClkDto 156, which uses the input clock (CLKI 150) directly. For video-capturing devices, such as cell phones, the input clock (CLKI 150) has a clock frequency of 26 MHz. A re-sampling module 170 is added to pass the YUV data from the ClkTiming domain (27 MHz) to ClkDto domain (e.g. 26 MHz for cell phones). There are many re-sampling methods to be implemented in the re-sample module 170, such as linear interpolation, band-limited interpolation and polyphase filtering. FIG. 3 shows one embodiment of implementation of re-sampling for Y data. Similar embodiments of re-sampling and diagrams can be drawn for U and V data. The embodiment shown in FIG. 3 utilizes linear interpolation. The filtered Y data 185 with timing and colorburst control are fed into the re-sampling module 170. The Y data (10 bits data) 185 belongs to the ClkTiming domain, which uses the 27 MHz clock generated by PLL 155. The Y data 185 is resampled by the re-sampling module 170 to become Y data 195 in the ClkDto domain, which is at a clock frequency other than 27 MHz (such as 26 MHz for cell phones). In one embodiment, the re-sampling module has circuits that handle luminance data, U components of the chrominance data, and V components of the chrominance data, separately and simultaneously.

In FIG. 3, the Y data 185 are fed into a deMUX 171 of the re-sampling module 170. The deMUX 171 has 8 data addresses, 0, 1, 2, 3, 4, 5, 6, and 7. DeMUX 171 places the Y data 185 in the 0-7 addresses sequentially into the corresponding 8 buffer addresses 0-7, which make up buffer 172. Buffer 172 receives Y data 185 from deMUX 171 and also 27 MHz clock signals from PLL 155, and produces Y data 185ₜ with timing to MUX 173. The number of addresses in the deMUX 171, buffer 172 and MUX 173 can be 4, 8, 16, etc., which can be represented by 2^{m} (m≧2). Larger jitter from PLL 155 would require more buffering addresses (or higher m value). MUX 173 combines data from buffer 172 and 3-bit integer part from a 32-bit accumulator 174. In one embodiment, 29 bits of the 32-bit accumulator 174 are used to provide a large integer number (2²⁹ or 536870912) for multiplication with the ratio of f_{ClkTiming}/f_{ClkDto} to advance sampling interval values corresponding to 26 MHz to be fed to the linear interpolation module (or linear interpolator) 190. The 32-bit accumulator increases by f_{ClkTiming}/f_{clkDto}*2²⁹ at every passing of clock ClkDto. In one embodiment, f_{ClkTiming}=27 MHz and f_{ClkDto}=26 MHz, the adder 177 in the accumulator increases 557519793 every clock, which helps the accumulator to advance 557519793/536870912 with the passage of every clock signal. In one embodiment, the interval advances from 0 to a 1^{st} interval according to a 26 MHz clock, which is 557519793/536870912 (or 1.03846153). The data corresponding to this 1^{st} interval is linearly interpolated between the Y data corresponding to n=1 and n+1=2. To obtain accurate interpolated values and accurate intervals, a large integer number is needed to ensure accurate interval values are obtained (e.g. 1.03846153 and 2.07692307, etc.). Therefore, 2²⁹ is used to generate the large integer number. The MUX 173 output data “n” and “n+1” to data buffers 188, 189. The data buffers 188, 189 takes in Y data corresponding to “n” and “n+1” and the 26 MHz clock signal. The data “n” and “n+1” are fed into the linear interpolation module 190 to perform linear interpolation. The output Y data 195 from the linear interpolation module 190 are in ClkDto 156 domain and are fed to MUX 145 and adder 144 of FIG. 2.

ResetA 181 and ResetB 182 of FIG. 3 are used to reset the integer counter 175 and accumulator 174. To ensure that the data in the 8 buffers are stable before they are used for linear interpolation, the two reset-signals, ResetA 181 and ResetB 182, are designed to have a clock gap. ResetA 181, which resets counter 175, occurs 2 or 3 clocks earlier than the ResetB 182, which resets 32-bit accumulator 174, to ensure that data are written in the deMux 171 before the data are read by MUX 173. The 3-bit counter always is 2 or 3 clocks ahead of the integer part of the 32-bit accumulator 174. The clock gap is limited by the number of buffers 172 available. In one embodiment, the clock gap is less than half of the buffer number (2^{m}/2 or 2^{m-1}). For 8 buffers, the clock gap should be less than 4 (or 1 to 3). The ResetA 181 and ResetB 182 are synchronized to happen at the same line as the reset signal for the DTO. ResetA 181 and ResetB 182 occur every 4 fields for NTSC and every 8 fields for PAL. In one embodiment, all resets take place at the beginning of the vertical non-display period (VNDP) to avoid accumulative errors.

Typically, video recorders have input clocks (CLKI) running at 27 MHz. This frequency gives integer number cycles per line for both PAL (1728 Clock cycles) and NTSC (1716 clock cycles), and meets the DTO requirement and TV bandwidth requirement. The integer number cycles per line make the logic circuit implementation relatively simple to generate accurate TV timing. However, as mentioned above, for some video-capturing devices, such as cell phones, the input clocks are not running at 27 MHz. The non-27 MHz clocks on these devices, such as 26 MHz clock for cell phones, are already available to use. Therefore, it is desirable to have an encoder utilizing the existing non-27 MHz clock. We will use 26 MHz clock for the cell phones as a non-27 MHz input clock example for the embodiment described below, however, the invention is not limited only to devices with 26 MHz clocks.

The implementation of the PAL-TV with 26 MHz clock for cell phone is more straightforward because it already has integer number (1664) clock cycles per line. But for NTSC-TV, there are about 1652.444 (actual value: 1652+4/9) clock cycles per line. If 26 MHz is used directly, the problem to implement non-integer number cycles per line needs to be solved.

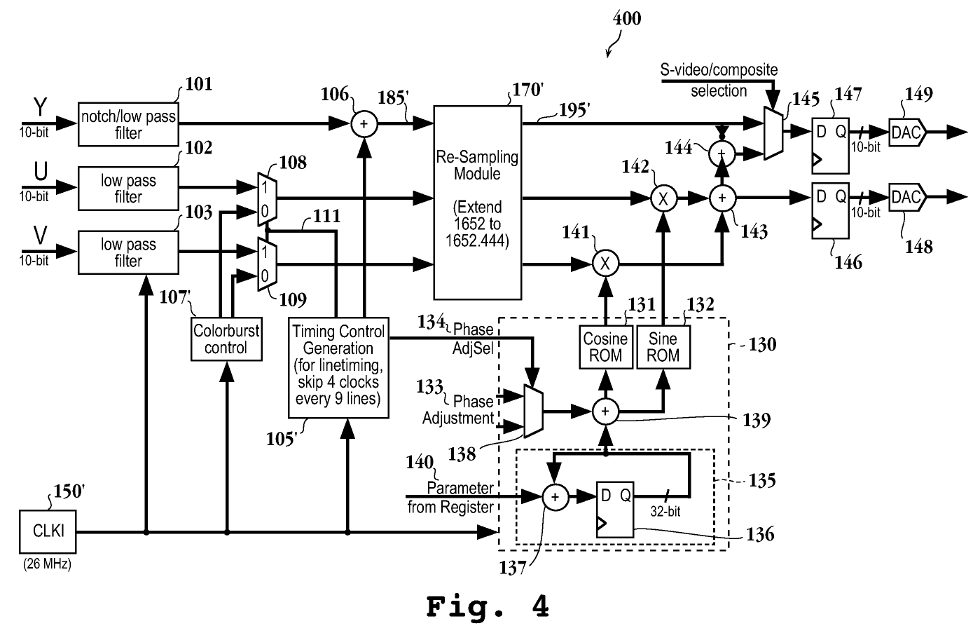

The embodiment described below provides a simple way to use x MHz clock (x does not equal 27), such as 26 MHz, instead of a 27 MHz clock in a TV digital encoder. This embodiment is suitable for video capturing devices that do not have a PLL on the device to generate 27 MHz clock signals. For FIG. 4 shows a TV encoder 400 with a re-Sampling module 170′. PLL is not needed in this embodiment to convert 26 MHz clock into 27 MHz clock. The concept of this embodiment focuses on extending video data captured by devices with a 26 MHz clock to be displayed on TV. This embodiment saves a PLL, which consumes power and space on the video capturing device. The TV encoder can be on a graphic engine chip on the cell phone or a separate chip.

These embodiments give a simple way to implement non-integer number cycles per line in a TV digital encoder. First, the encoder generates the line timing based on the integer part: 1652 cycles/Line. But at every 9th line, the clock is stopped for 4 cycles, which gives extra 4 clock cycles in 9 lines. On average there is about 1652.444 (accurately 1652 4/9) clocks per line. However TV decoder cannot tolerate sudden line length change. Therefore, a re-sampling module 490 is needed to make the change smoothly.

FIG. 4 shows a diagram of an exemplary embodiment of a TV encoder 400 that encodes digital video taken with a device with an input clock frequency other than 27 MHz. The clock frequency applicable to the embodiment shown in FIG. 4 ranges from about 18 MHz to less than 27 MHz, or higher than 27 MHz. This embodiment is providing a simple way to use existing input clock in the video capturing device, such as 26 MHz for a cell phone. The clock used for Discrete Time Oscillator (DTO) 130 and for timing generation and color burst control is the input clock (CLKI) 150.

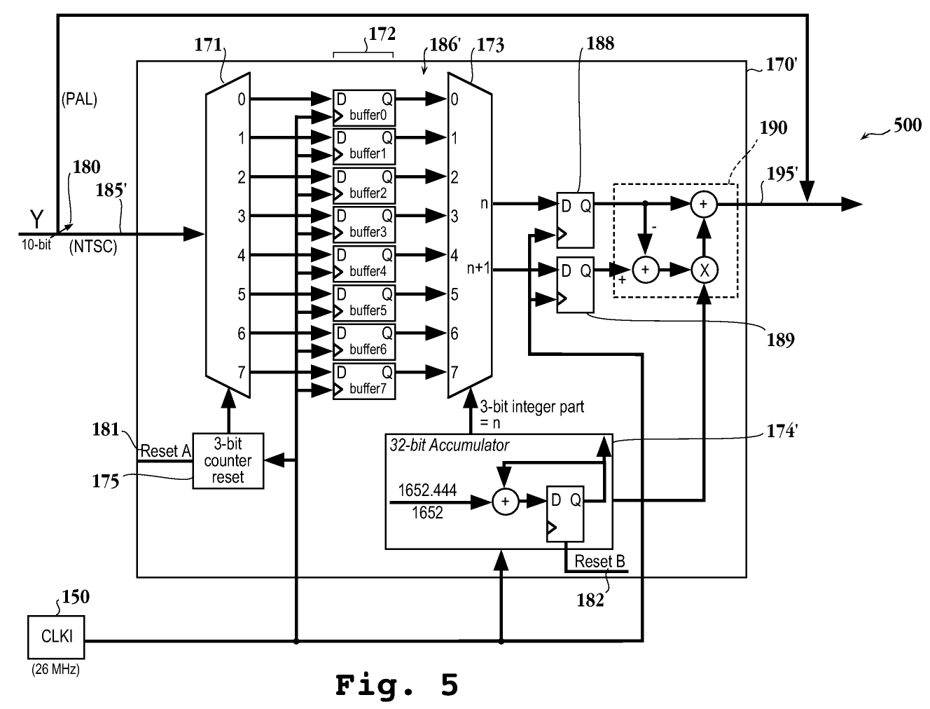

The filtered YUV data with timing control and color burst control are generated at the same clock as the sine/cosine modulation values. To extend the data from 1652 cycles/line to about 1652.444 (accurately 1652 4/9) cycles/line, a re-sampling module 170′ is needed. FIG. 5 shows a schematic diagram of the re-sampling module 170′. FIG. 5 shows one embodiment of implementation for Y data. Similar diagrams can be drawn for U and V data. The re-sampling module has circuits that handle luminance data, U components of the chrominance data, and V components of the chrominance data separately and simultaneously.

The embodiment shown in FIG. 5 utilizes linear interpolation. Before the filter data go into the re-sampling module 170′, there is a switch 180. For PAL systems, the entire re-sampling module 170′ is by-passed. PAL systems have integer number of cycles per line and do not require data re-sampling. For NTSC systems, filtered Y data 185′ are fed into a deMUX 171 of the re-sampling module 170′. The deMUX 171 has 8 data addresses, 0, 1, 2, 3, 4, 5, 6, and 7. DeMUX 171 places the Y data 185′ in the 0-7 addresses in deMUX 171 sequentially into the corresponding 8 buffer addresses 0-7, which make up buffer 172. Buffer addresses 0-7, receiving Y data 185′ from deMUX 171 and also 26 MHz clock signals from CLKI, transfer data 185′ₜ to MUX 173. MUX 173 combines data from buffer 172 and 3-bit integer part (n) from a 32-bit accumulator 174′. As described above, 29 bits of the 32-bit accumulator is used to provide a large integer number (2²⁹ or 536870912) to provide accurate ratio of 1652.444/1652 (or 1652 4/9/1652). The 32-bit accumulator increases by 1652.444/1652*2²⁹ (or 1652 4/9/1652*2²⁹) at every passing of clock CLKI to generate an accurate fraction to feed to the linear interpolation module (or linear interpolator) 170′. The MUX 173 produces data “n” and “n+1” to data buffers 188, 189. The data buffers 188, 189 takes in Y data “n” and “n+1” and their corresponding 26 MHz clock signals to feed Y data n and n+1 to the linear interpolation module (or linear interpolator) 190. The Y data “n” and “n+1” fed into the linear interpolation module 190′ are used to perform linear interpolation. The output Y data 195′ from the linear interpolation module 190 are fed to MUX 145 and adder 144 of FIG. 4.

As described above, to ensure that the data in the 8 buffers are stable before they are used for linear interpolation, the two reset-signals, ResetA 181 and ResetB 182, are designed to have a clock gap. ResetA 181, which resets counter 175, occurs 2 or 3 clocks earlier than the ResetB, which resets the 32-bit accumulator 174 to ensure that there is data written in the deMux 171 before the data is read in MUX 173. The 3-bit counter always is 2 or 3 clocks ahead of the integer part of the 32-bit accumulator 174. The clock gap is limited by the number of buffers 172 available. In one embodiment, the clock gap is less than half of the buffer address number. For 8 buffers, the clock gap should be less than 4 (or 1 to 3). The ResetA 181 and ResetB 182 are synchronized to happen at the same line as the reset signal for the DTO. ResetA 181 and ResetB 182 occur every 4 fields for NTSC and every 8 fields for PAL. In one embodiment, all resets take place at the beginning of the vertical non-display period (VNDP) to avoid accumulative errors.

The x MHz clock shown in FIG. 4 and FIG. 5 has a clock frequency at about 26 MHz. However, video capturing devices with clock frequency, other than 26 MHz and 27 MHz and ranging from about 18 MHz to less than 27 MHz (or higher than 27 MHz), can also utilize the concept of the embodiment. In addition, the embodiments described above utilize linear interpolation, other interpolation methods, such as band-limited interpolation and polyphase filtering can also be used.

The embodiments described above provide methods and devices that allow videos captured by devices, such as cell phones, to be encoded without using an additional clock module that would generate low jitter input clock frequency. The devices and methods described above either indirectly use a PLL to generate a 27 MHz clock frequency to handle the timing control and color burst control that are not sensitive to clock jitter or directly use input clock other than 27 MHz to encode videos. Encoding videos without using an additional input clock at a frequency other than 27 MHz saves power and real estate on the video capturing device. Encoding videos without using a PLL further saves power and space on the video capturing device.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An encoding device capable of using two clock frequencies to encode digital video data, the device comprising:
an input clock operating at a clock frequency other than 27 MHz;
a phase-locked loop (PLL) configured to generate a 27 MHz clock from the input clock;
a re-sampling module to convert luminance and chrominance data representing the digital video data from a 27 MHz clock domain to a clock domain of the input clock;
a color subcarrier generator driven by the input clock to generate color subcarrier signals, the chrominance data from the re-sampling module are modulated by the color subcarrier signals, wherein modulated chrominance data are eventually combined with the luminance data from the re-sampling module; and
a digital to analog converter (DAC) to convert the modulated chrominance data, which are eventually combined with the luminance data from the re-sampling module, into analog signals.

2. The encoding device of claim 1, wherein the re-sampling module further comprises:
a de-multiplexer with 2^{m} addresses where m is ≧2, wherein the de-multiplexer receives luminance or chrominance data and address signals from a m-bit integer counter and the m-bit integer counter is driven by the PLL;
2^{m} buffers coupled to the de-multiplexer to store data written in the 2^{m} addresses of the de-multiplexer, wherein the 2^{m} buffers are made of flip/flops or other memory cells and each buffer receives clock signals from the PLL;
a multiplexer with 2^{m} addresses, coupled to the 2^{m} buffers to merge 2^{m} data stored in the 2^{m} buffers and receiving a 3-bit integer number n from an accumulator to produce two sequential data stored in addresses n and n+1; and
a linear interpolator coupled to a 32-bit accumulator, which is coupled to the multiplexer, to interpolate luminance or chrominance data in the input clock domain.

3. The encoding device of claim 2, wherein the re-sampling module further comprises:
two data buffers coupled to the multiplexer, the two data buffers configured to receive the two sequential data, wherein the two data buffers are driven by clock signals of the input clock, the two data buffers providing input data to the linear interpolator.

4. The encoding device of claim 1, wherein the re-sampling module has circuits that handle luminance data, U components of the chrominance data, and V components of the chrominance data separately and contemporaneously.

5. The encoding device of claim 1, wherein the color subcarrier generator is an one-stage discrete time oscillator (DTO) that generates input-clock-frequency-based sine and cosine values to modulate U and V components of the chrominance data from the re-sampling module.

6. The encoding device of claim 1, wherein the encoding device is incorporated into a graphic processing unit.

7. The encoding device of claim 1, wherein the input clock has a clock frequency between about 18 MHz and about 26 MHz.

8. The encoding device of claim 1, wherein the input clock frequency is 26 MHz.

9. The encoding device of claim 1, wherein the encoding device supports both NTSC and PAL standards.

10. The encoding device of claim 1, further comprising:
a plurality of filters to filter luminance and chrominance data;
a timing control generator to add timing control to the luminance data with the clock signals generated by the PLL; and
a color burst control generator to add color burst control to the chrominance data, wherein the color burst is synchronized with the timing control of the luminance data, wherein the luminance and the chrominance data with added timing control and color burst control provide the first number of data and the second number of data extended by the re-sampling module.

11. A method capable of using two clock frequencies to encode digital video data captured by a video-capturing device, the method comprising:
re-sampling luminance and chrominance data in a re-sampling module to convert the luminance and the chrominance data in a 27 MHz clock domain to be in an input clock domain other than 27 MHz of an input clock of the video-capturing device;
modulating re-sampled chrominance data in the input clock domain by color subcarrier signals driven by the input clock;
combining the modulated re-sampled chrominance data and the re-sampled luminance data; and
converting the combined modulated re-sampled chrominance data and re-sampled luminance data into analog signals.

12. The method of claim 11, further comprising:
filtering the luminance and the chrominance data before re-sampling;
adding timing control to the luminance data after filtering and before re-sampling, with a 27 MHz clock, wherein the 27 MHz clock is generated by a phase-locked loop (PLL) driven by the input clock; and
adding color burst control to the chrominance data after filtering and before re-sampling, wherein the color burst is synchronized with the timing control of the luminance data.

13. The method of claim 11, wherein re-sampling the luminance and chrominance data is performed by a method selected from the group consisting of linear interpolation, band-limited interpolation and polyphase filtering.

14. The method of claim 11, wherein re-sampling the luminance and chrominance data is performed through a de-multiplexer, 2^{m} buffers, a multiplexer coupled to a 32-bit accumulator, and a linear interpolator to convert luminance and chrominance data from the 27 MHz clock domain to the input clock domain.

15. The method of claim 14, wherein m is 3.

16. The method of claim 14, wherein the number of buffers increases with the degree of jitter.

17. The method of claim 14, wherein the de-multiplexer is coupled to a 3-bit integer counter and the multiplexer is coupled to a 3-bit integer generator of the 32-bit accumulator, and wherein the 3-bit integer counter is 3 clock cycles ahead of the 32-bit accumulator to the multiplexer.

18. The method of claim 11, wherein re-sampling the luminance and the chrominance data handles luminance data, U components of the chrominance data, and V components of the chrominance data separately and contemporaneously.

19. The method of claim 11, wherein the color carrier signals are sine and cosine values used to modulate U and V components of the chrominance data from the re-sampling module.

20. The method of claim 11, wherein the input clock frequency is about 26 MHz.

21. The method of claim 11, wherein the method supports both NTSC and PAL standards.
